(19) United States
(12) Patent Application Publication
(10) Pub. No.: US 2021/0098767 A1
(43) Pub. Date: Apr. 1, 2021

(54) BATTERY CELL FOR ELECTRIC VEHICLE AND METHOD FOR MANUFACTURING THE SAME

(71) Applicants: Hyundai Motor Company, Seoul (KR); Kia Motors Corporation, Seoul (KR)

(72) Inventor: Se Hyun Kim, Seoul (KR)

(21) Appl. No.: 16/831,453

(22) Filed: Mar. 26, 2020

(30) Foreign Application Priority Data
Sep. 30, 2019 (KR) 10-2019-0120446

(51) Int. Cl. H01M 2/26; H01M 4/66; H01M 10/0585

(52) U.S. Cl. CPC H01M 2/266; H01M 2220/20; H01M 10/0585; H01M 4/661

(57) ABSTRACT

A battery cell for an electric vehicle is provided and includes a plurality of positive electrode plates each including a positive current collector coated with a positive active material and having a plurality of positive electrode terminals in one direction, a plurality of negative electrode plates each including a negative current collector coated with a negative active material and having a plurality of negative electrode terminals in an opposite direction. The battery cell also includes a plurality of separators each including a film member coated with an insulating material and interposed between adjacent pair of the positive electrode plate and the negative electrode plate.

### CROSS-REFERENCE TO RELATED APPLICATION

This application claims priority to and the benefit of Korean Patent Application No. 10-2019-0120446 filed on Sep. 30, 2019, the entire contents of which are incorporated herein by reference.

### BACKGROUND

### (a) Field of the Disclosure

The present disclosure relates to a battery cell for an electric vehicle and a method for manufacturing the same, and more particularly, to a battery cell that enables multiplication of current flow through the electrode terminals and minimizes resistance during charging and discharging.

### (b) Description of the Related Art

Currently used secondary batteries include a nickel cadmium battery, a nickel hydrogen battery, a nickel zinc battery, and a lithium secondary battery. Among such batteries, a lithium secondary battery is often preferred due to the merit of free charging and discharging, a very low self-discharge rate, and a high energy density, in comparison with nickel-based secondary batteries.

Such lithium secondary batteries typically use lithium-based oxides and carbon materials as positive active materials and negative active materials, respectively. The lithium secondary battery includes an electrode assembly and an exterior member that seals the electrode assembly with the electrolyte solution. In a typical electrode assembly, a positive electrode plate is formed by a positive current collector coated with a positive active material, a negative electrode plate is formed by a negative current collector coated with a negative active material, and a separator is disposed between the positive and negative electrode plates.

The lithium secondary battery may be classified, according to a shape of the battery case, into a can-type secondary battery in which an electrode assembly is installed in a metal can, and a pouch-type secondary battery in which an electrode assembly is installed in a pouch of an aluminum laminate sheet. Recently, secondary batteries have been widely used not only for small devices such as portable electronic devices but also for medium and large devices such as automobiles and energy storage devices (ESS).

When used in such a medium-large device, a substantial number of secondary batteries are electrically interconnected to form a battery module and a battery pack to increase capacity and output. In particular, the pouch-type secondary battery is widely used in such a medium-large device due to its merit of easy stacking and being light weight. The battery cell including the pouch-type secondary battery has a sealed structure in which an electrode assembly having positive and negative electrodes respectively connected to electrode terminals is housed together with an electrolyte solution in a pouch case. Some of the electrode terminals are exposed to the outside of the pouch case, and the exposed electrode terminals are used to electrically connect the device on which the battery cell is mounted, or to electrically connect the positive and negative electrodes to each other.

In conventional battery cells, current flows through the positive and the negative electrode terminals during charging and discharging, and to minimize resistance, it is common to thicken the positive and negative terminals. In such a conventional battery cell having thicker positive and negative electrode terminals, welding characteristic may deteriorate, and may thus crack and disconnection of the positive and negative electrode terminals in the manufacturing process may occur. In addition, according to a conventional battery cell, the thick thickness of the positive and negative electrode terminals may cause quality deterioration of the module welding during a secondary welding of the stacked terminals in a module assembly process.

The above information disclosed in this section is merely for enhancement of understanding of the background of the disclosure and therefore it may contain information that does not form the prior art that is already known in this country to a person of ordinary skill in the art.

### SUMMARY

The present disclosure provides a battery cell for an electric vehicle and a method for manufacturing the same having advantages of employing a plurality of positive electrode terminals and negative electrode terminals, thereby enabling multiplication of current flow through the electrode terminals, and minimizing resistance during charging and discharging. By employing a plurality of positive electrode terminals and negative electrode terminals, thickness of terminals may be reduced, and therefore, welding quality may be improved, thereby improving product quality.

An exemplary battery cell for an electric vehicle may include a plurality of positive electrode plates each including a positive current collector coated with a positive active material and having a plurality of positive electrode terminals in a first direction, a plurality of negative electrode plates each including a negative current collector coated with a negative active material and having a plurality of negative electrode terminals in a second direction (e.g., opposite to the first direction), and a plurality of separators each including a film member coated with an insulating material and interposed between adjacent pair of the positive electrode plate and the negative electrode plate.

A first positive electrode tab and a second positive electrode tab uncoated with the positive active material may be formed apart by a predetermined spacing in each of the positive electrode plates. A first positive electrode terminal may be electrically connected to the first positive electrode tab. A second positive electrode terminal may be electrically connected to the second positive electrode tab. The first and second positive electrode terminals may be formed in a width in a range of about 40 mm to 50 mm and in a thickness in a range of about 0.1 mm to 0.2 mm. The first and second positive electrode terminals may be symmetrically formed at both sides with respect to a center in a length direction of the positive electrode plate.

A first negative electrode tab and a second negative electrode tab uncoated with the negative active material may be formed spaced apart from each other by a predetermined spacing in each of the negative electrode plate. A first negative electrode terminal may be electrically connected to the first negative electrode tab. A second negative electrode terminal may be electrically connected to the second negative electrode tab. The first and second negative electrode terminals may be formed in a width in a range of about 40 mm to 50 mm and in a thickness in a range of about 0.05 mm to 0.1 mm. The first and second negative electrode terminals may be symmetrically formed at both sides with respect to a center in a length direction of the negative electrode plate.

The plurality of positive electrode plates and the plurality of negative electrode plates may be stacked alternately to dispose the positive electrode terminals and the negative electrode terminals in opposite directions. Each adjacent pair of the positive and negative plates may be insulated from each other by interposing the separator.

An exemplary battery cell for an electric vehicle may further include a pouch for sealing the positive electrode plates, the negative electrode plates, and the separators, while exteriorly exposing the positive electrode terminal and the negative electrode terminal. The positive electrode plate may include a positive current collector formed of an aluminum (Al) thin film material, and the negative electrode plate may include a negative current collector formed of a copper (Cu) thin film material.

An exemplary method for manufacturing a battery cell for an electric vehicle may include forming a plurality of positive electrode plates each having a first positive electrode tab and a second positive electrode tab, forming a plurality of negative electrode plates each having a first negative electrode tab and a second negative electrode tab, forming a plurality of separators each having a film member coated with an insulating material at both sides, forming an electrode assembly by stacking the plurality of positive electrode plates, the plurality of negative electrode plates, and the plurality of separators to alternately stack the positive electrode plates and the negative electrode plates and each adjacent pair of the positive and negative electrode plates may be insulated by interposing the separator, and connecting a plurality of positive electrode terminals to the positive electrode plates and a plurality of negative electrode terminals to the negative electrode plates.

The forming of the plurality of positive electrode plates may include forming a positive electrode coated portion by coating a positive active material to both sides of a positive current collector except for a margin including a positive electrode tab portion, loading the positive current collector to a notching die, and forming the positive electrode plate by cutting the positive electrode tab portion to form the first positive electrode tab and the second positive electrode tab, and by cutting the positive current collector by a predetermined interval. The notching die may include an upper die having a plurality of tab protrusions to form the first and second positive electrode tabs and a cutter blade for cutting the positive current collector by a predetermined interval, and a lower die having a plurality of tab grooves that correspond to the plurality of tab protrusions and a cutter groove that corresponds to the cutter blade.

The forming of the plurality of negative electrode plates may include forming a negative electrode coated portion by coating a negative active material to both sides of a negative current collector except for a margin including a negative electrode tab portion, loading the negative current collector to a notching die, and forming the negative electrode plate by cutting the negative electrode tab portion to form the first negative electrode tab and the second negative electrode tab, and by cutting the negative current collector by a predetermined interval.

The notching die may include an upper die having a plurality of tab protrusions to form the first and second negative electrode tabs and a cutter blade for cutting the negative current collector by a predetermined interval, and a lower die having a plurality of tab grooves that correspond to the plurality of tab protrusions and a cutter groove that corresponds to the cutter blade. The forming of the electrode assembly may include welding the first positive electrode tabs of the plurality of positive electrode plates, welding the second positive electrode tabs of the plurality of positive electrode plates, welding the first negative electrode tabs of the plurality of negative electrode plates, and welding the second negative electrode tabs of the plurality of negative electrode plates.

The connecting of the plurality of positive electrode terminals to the positive electrode plates and the plurality of negative electrode terminals to the negative electrode plates may include loading the electrode assembly into a welding jig, loading a first positive electrode terminal and a first negative electrode terminal to the first positive electrode tab and the first negative electrode tab, respectively, welding the first positive electrode terminal and the first negative electrode terminal to the first positive electrode tab and the first negative electrode tab, respectively, by a welding horn, loading a second positive electrode terminal and a second negative electrode terminal to the second positive electrode tab and the second negative electrode tab, respectively, and welding the second positive electrode terminal and the second negative electrode terminal to the second positive electrode tab and the second negative electrode tab, respectively, by moving the welding horn. The welding may include ultrasonic welding.

An exemplary method for manufacturing a battery cell may further include sealing the electrode assembly by a pouch while exteriorly exposing at least a part of the electrode terminals. According to a battery cell for an electric vehicle and a method for manufacturing the same according to an exemplary embodiment, a plurality of positive electrode terminals and negative electrode terminals may be employed, e.g., a pair. Therefore, thickness of respective terminals may be reduced, thereby improving welding quality and improving output performance. Further, effects that may be obtained or expected from exemplary embodiments of the present disclosure are directly or suggestively described in the following detailed description. In other words, various effects expected from exemplary embodiments of the present disclosure will be described in the following detailed description.

### BRIEF DESCRIPTION OF THE DRAWINGS

The above and other features of the present disclosure will now be described in detail with reference to exemplary embodiments thereof illustrated in the accompanying drawings which are given hereinbelow by way of illustration only, and thus are not limitative of the present disclosure, and wherein:

FIG. 1 is a detailed view of a battery cell for an electric vehicle according to an exemplary embodiment;

FIG. 2 is a perspective view illustrating a positive electrode plate, a separator, and a negative electrode plate applied to a battery cell for an electric vehicle according to an exemplary embodiment; and

FIG. 3 to FIG. 5 are process diagrams sequentially illustrating a method for manufacturing a battery cell for an electric vehicle according to an exemplary embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure. The drawings and description are to be regarded as illustrative in nature and not restrictive, and like reference numerals designate like elements throughout the specification. In the following description, dividing names of components into first, second and the like is to divide the names because the names of the components are the same as each other and an order thereof is not particularly limited.

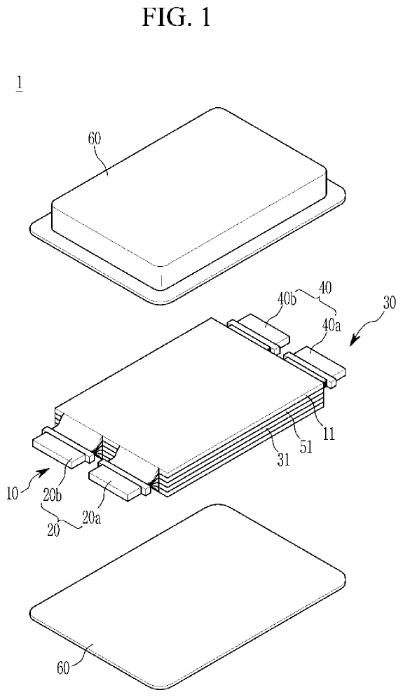

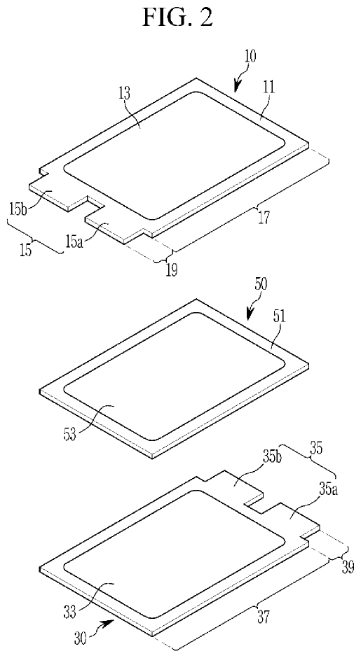

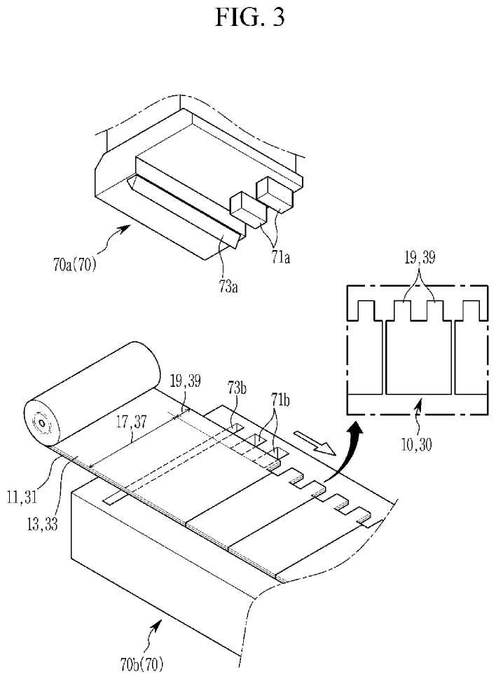

FIG. 1 is a detailed view of a battery cell for an electric vehicle according to an exemplary embodiment. FIG. 2 is a perspective view illustrating a positive electrode plate, a separator, and a negative electrode plate applied to a battery cell for an electric vehicle according to an exemplary embodiment. FIG. 3 to FIG. 5 are process diagrams sequentially illustrating a method for manufacturing a battery cell for an electric vehicle according to an exemplary embodiment.

A battery cell 1 for an electric vehicle and a method for manufacturing the same according to an exemplary embodiment may be applicable to a pouch-type lithium secondary battery applicable to an electric vehicle. The battery cell applied to the pouch-type lithium secondary battery may use a lithium metal battery having lithium metal as a negative active material, and may be applied to an electric vehicle due to capability of charging and discharging and due to high energy density.

Referring to FIG. 1 and FIG. 2, such a battery cell 1 for an electric vehicle may include a positive electrode plate 10, a negative electrode plate 30, a separator 50, and a pouch 60. The battery cell 1 may be electrically connected by stacking the positive electrode plate 10, the negative electrode plates 30, and the separators 50, in a range of about 20-30 sheets. A plurality of battery cells 1 may be stacked to form a battery module, and a plurality of battery modules may form a battery pack. The battery pack may be installed within an electric vehicle, e.g., at a bottom of the electric vehicle, and may operate as an electric power source to drive the electric vehicle.

The positive electrode plate 10 of a battery cell 1 for an electric vehicle according to an exemplary embodiment may include a positive current collector 11 applied with positive active material 13 at both sides thereof. The positive current collector 11 may be formed of an aluminum (Al) thin film material. Both surfaces of the positive current collector 11 may be coated with a positive active material 13 including a metal oxide containing lithium, for example, lithium cobalt oxide (LiCoO₂).

It may be understood that the positive active material 13 may be applied to only one surface of the positive current collector 11, not necessarily to both surfaces of the positive current collector 11. In addition, the positive active material 13 may be applied to the positive current collector 11 with a margin to an edge of the positive current collector 11.

The positive electrode plate 10 may be divided into a positive electrode coated portion 17 that is coated with the positive active material 13 and a positive electrode tab portion 19 that is not coated with the positive active material 13. Through the positive electrode tab portion 19, the positive electrode plate 10 may form a first positive electrode tab 15a and a second positive electrode tab 15b spaced apart from each other. The first positive electrode tab 15a and the second positive electrode tab 15b may be formed symmetrically at both sides with respect to the center, e.g., in a length direction of the positive electrode plate 10.

In addition, the positive electrode plate 10 may include a plurality of positive electrode terminals 20 that protrude outwardly. The plurality of positive electrode terminals 20 may include a first positive electrode terminal 20a electrically connected to the first positive electrode tabs 15a and a second positive electrode terminal 20b electrically connected to the second positive electrode tabs 15b. The first positive electrode terminal 20a and the second positive electrode terminal 20b may be electrically connected to the first positive electrode tab 15a and the second positive electrode tab 15b, respectively. The same as the first and second positive electrode tabs 15a and 15b, the first and second positive electrode terminals 20a and 20b may be formed symmetrically at both sides with respect to the center of the positive electrode plate 10.

The width of the first and second positive electrode terminals 20a and 20b may be set in a range of about 40 mm to 50 mm. In addition, the thickness of the first and second positive electrode terminals 20a and 20b may be set in a range of about 0.1 mm to 0.2 mm. It may be understood that the thickness of the positive electrode terminals set in the range of about 0.1 mm to 0.2 mm according to an exemplary embodiment is significantly thinner than a conventional thickness that is typically set in a range of 0.4 mm to 0.6 mm.

The negative electrode plate 30 of a battery cell 1 for an electric vehicle according to an exemplary embodiment may include a negative current collector 31 applied with negative active material 33 at both sides thereof. The negative current collector 31 may be formed as a copper (Cu) thin film material. Both surfaces of the negative current collector 31 may be coated with the negative active material 33 containing carbon. It may be understood that the negative active material 33 may be applied to only one surface of the negative current collector 31, not necessarily to both surfaces of the negative current collector 31. In addition, the negative active material 33 may be applied to the negative current collector 31 with a margin to an edge of the negative current collector 31.

The negative electrode plate 30 may be divided into a negative electrode coated portion 37 that is coated with the negative active material 33 and a negative electrode tab portion 39 that is not coated with the negative active material 33. Through the negative electrode tab portion 39, the negative electrode plate 30 may form a first negative electrode tab 35a and a second negative electrode tab 35b spaced apart from each other. The first negative electrode tab 35a and the second negative electrode tab 35b may be formed symmetrically at both sides with respect to the center, e.g., in a length direction of the negative electrode plate 30.

In addition, the negative electrode plate 30 may include a plurality of negative electrode terminals 40 that protrude outwardly. The plurality of negative electrode terminal 40 may include a first negative electrode terminal 40a electrically connected to the first negative electrode tabs 35a and a second negative electrode terminal 40b electrically connected to the second negative electrode tabs 35b. The first negative electrode terminal 40a and the second negative electrode terminal 40b may be electrically connected to the first negative electrode tab 35a and the second negative electrode tab 35b, respectively. The same as the first and second negative electrode tabs 35a and 35b, the first and second negative electrode terminals 40a and 40b may be formed symmetrically at both sides with respect to the center of the negative electrode plate 30.

The width of the first and second negative electrode terminals 40a and 40b may be set in a range of about 40 mm to 50 mm. In addition, the thickness of the first and second negative electrode terminal 40a and 40b may be set in a range of about 0.05 mm to 0.1 mm. It may be understood that the thickness of the negative electrode terminals set in the range of about 0.1 mm to 0.2 mm according to an exemplary embodiment is significantly thinner than a conventional thickness that is typically set in a range of 0.4 mm to 0.6 mm.

The separator 50 of a battery cell 1 for an electric vehicle according to an exemplary embodiment may include a film member 51 applied with an insulating material 53 at both sides thereof. The film member 51 may include a polyethylene, polypropylene, etc. In addition, the insulating material 53 may be formed of a ceramic material.

The positive electrode plate 10, the negative electrode plate 30, and the separator 50 may be alternately stacked to dispose the positive electrode terminal 20 and the negative electrode terminal 40 in opposite directions, and the separator 50 may be interposed therebetween. In other words, a plurality of layers of the positive electrode plate 10, the separator 50, the negative electrode plate 30, and the separator 50 may be stacked, and may be arranged to align the positive electrode tabs 15 of the positive electrode plate 10 with each other, and to the negative electrode of the negative electrode plate 30 with each other.

The separator 50 may be interposed between the positive electrode plate 10 and the negative electrode plate 30 to prevent the contact between the positive electrode plate 10 and the negative electrode plate 30, thereby increasing stability. In addition, the pouch 60 of a battery cell 1 for an electric vehicle according to an exemplary embodiment may seal the stack of the plurality of the positive electrode plates 10, the negative electrode plates 30, and the separators 50, while exposing the two positive electrode terminals 20 and the two negative electrode terminal 40. The pouch 60 may be filled with an electrolyte solution. The pouch 60 may include a metal thin film.

A method for manufacturing a battery cell for an electric vehicle according to an exemplary embodiment is as follows. Referring to FIG. 3, firstly, a positive electrode plate 10 may be formed. For the positive electrode plate 10, the positive active material 13 may be coated on both sides of the positive current collector 11, except for a margin including the positive electrode tab portion 19.

Particularly, the portion of the positive electrode plate 10 coated with the positive active material 13 may be referred to as the positive electrode coated portion 17.

Subsequently, the positive current collector 11 may be loaded at a notching die 70, and the positive electrode tab portion 19 may be cut. By the notching die 70, the positive electrode tab portion 19 may be cut to form the first positive electrode tab 15a and the second positive electrode tab 15b that are spaced apart from each other. At the same time, by the notching die 70, the positive current collector 11 may be cut by a predetermined interval to form the positive electrode plate 10.

The notching die 70 may include an upper die 70a and a lower die 70b. The upper die 70a may include tab protrusions 71a to form the first and second positive electrode tabs 35a and 35b, and the lower die 70b may include tab grooves 71b corresponding to the tab protrusions 71a. In addition, the upper die 70a may include a cutter blade 73a for cutting the positive current collector 11 by the predetermined interval. The lower die 70b may include a cutter groove 73b that corresponds to the cutter blade 73a. In other words, the notching die 70 may cut the positive current collector 11 by the predetermined interval by the cutter blade 73a of the upper die 70a and the cutter groove 73b of the lower die 70b to form the positive electrode plate 10.

Subsequently, the negative electrode plate 30 may be formed. For the negative electrode plate 30, the same as for the positive electrode plate 10, the negative active material 33 may be coated on both sides of the negative current collector 31, except for a margin including the negative electrode tab portion 39. Particularly, the portion of the negative electrode plate 30 coated with the negative active material 33 may be referred to as the negative electrode coated portion 37.

Subsequently, the negative current collector 31 may be loaded at the notching die 70, and the negative electrode tab portion 39 may be cut. By the notching die 70, the negative electrode tab portion 39 may be cut to form the first negative electrode tabs 35a and the second negative electrode tab 35b that are spaced apart. At the same time, by the notching die 70, the negative current collector 31 may be cut by a predetermined interval to form the negative electrode plate 30. It may be understood that the die notching die 70 used for forming the positive electrode plate 10 may be used for forming the negative electrode plate 30. Subsequently, the separator 50 may be formed. In particular, the separator 50 may be formed by coating an insulating material 53 on both sides of film member 51, as illustrated in FIG. 1.

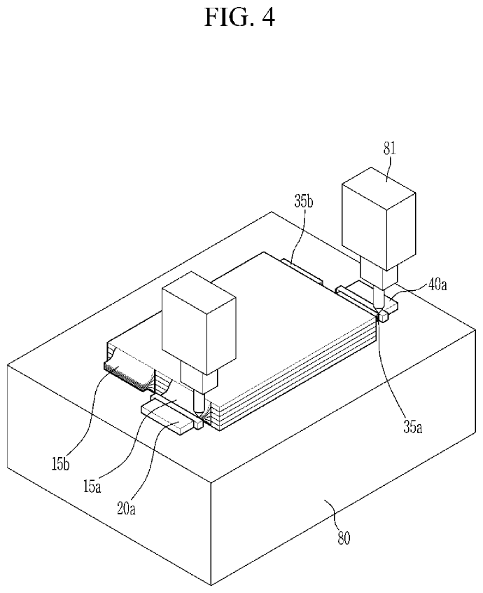

Referring to FIG. 4, the positive electrode plate 10, the separator 50, the negative electrode plate 30, and the separator 50 may be stacked continuously (e.g., multiple alterations of the components may be stacked) to form an electrode assembly. The positive electrode plates 10 and the negative electrode plates 30 may be stacked interposing the separators 50, e.g., in a range of about 20 to 30 sheets respectively, to form the electrode assembly.

The positive electrode tabs 15 of the positive electrode plates 10 and the negative electrode tabs 35 of the negative electrode plates 30 may be disposed in opposite directions, while maintaining the positive electrode tabs 15 in the same direction and position and the negative electrode tabs 35 in the same direction and position. To form the electrode assembly, the positive electrode tabs 15 may be welded together and the negative electrode tabs 35 may be welded together. In other words, the first positive electrode tabs 15a of the plurality of positive electrode plates 10 may be welded together, the second positive electrode tabs 15b of the plurality of positive electrode plates 10 may be welded together, the first negative electrode tabs 35a of the plurality of negative electrode plates 10 may be welded together, and the second negative electrode tabs 35b of the plurality of negative electrode plates 10 may be welded together.

Subsequently, the electrode assembly may be loaded into the welding jig 80, and then the first positive electrode terminal 20a and the first negative electrode terminal 40a may be respectively loaded on the first positive electrode tab 15a and the first negative electrode tab 35a, respectively. By welding horns 81, the first positive electrode tab 15a and the first positive electrode terminal 20a may be electrically connected to each other by welding, and the first negative electrode tab 35a and the first negative electrode terminal 40a may be electrically connected to each other by welding.

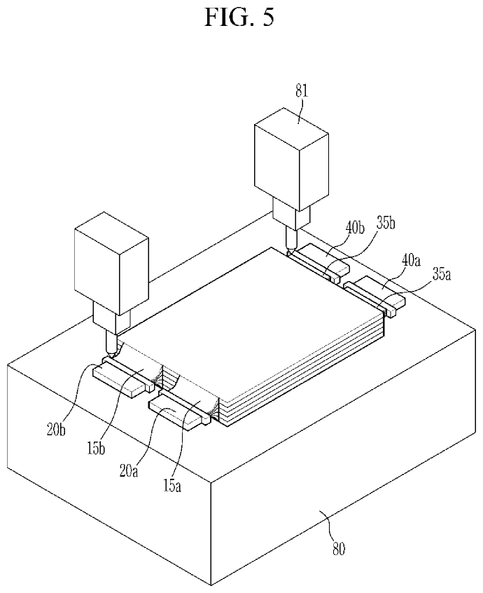

Referring to FIG. 5, the second positive electrode terminal 20b and the second negative electrode terminal 40b may be respectively loaded on the second positive electrode tab 15b and the second negative electrode tab 35b, respectively. The welding horns 81 may be moved, and by the welding horns 81, the second positive electrode tab 15b and the second positive electrode terminal 20b may be electrically connected to each other by welding, and the second negative electrode tab 35b and the second negative electrode terminal 40b may be electrically connected to each other by welding.

The positive electrode terminals 20 and the negative electrode terminals 40 may be welded to the positive electrode tabs 15 and the negative electrode tabs 35, e.g., by ultrasonic welding or laser welding, but the present disclosure is not limited thereto. Finally, the stack of the positive electrode plates 10, the negative electrode plates 30, and the separators 50 therebetween may be sealed by the pouch 60, while exteriorly exposing the first and second positive electrode terminals 20a and 20b and the first and second negative electrode terminals 40a and 40b. At this time, the electrolyte solution may be filled in the pouch 60.

Therefore, according to a battery cell for an electric vehicle and a method for manufacturing the same according to an exemplary embodiment, a plurality of positive electrode terminals 20 and negative electrode terminals 40 are employed, e.g., by a pair, and therefore, thickness of respective terminals may be reduced. Accordingly, welding quality may be improved. In addition, according to a battery cell for an electric vehicle and a method for manufacturing the same according to an exemplary embodiment, a current flow through the electrode terminal may be multiplied, and thereby resistance during charging and discharging may be minimized. According to a battery cell for an electric vehicle and a method for manufacturing the same according to an exemplary embodiment, conventional welding equipment may be used, and therefore, the product quality may be improved without causing extra investment cost.

In addition, according to a battery cell for an electric vehicle and a method for manufacturing the same according to an exemplary embodiment, two positive electrode tabs 15 and two negative electrode tabs 35 may be simultaneously formed at the positive electrode plate 10 and the negative electrode plate 30, respectively, by altering the form of a notching die 70. Therefore, an overall productivity may be improved and an overall production cycle time may be reduced.

While this disclosure has been described in connection with what is presently considered to be practical exemplary embodiments, it is to be understood that the disclosure is not limited to the disclosed exemplary embodiments. On the contrary, it is intended to cover various modifications and equivalent arrangements included within the spirit and scope of the appended claims.

### DESCRIPTION OF SYMBOLS

1: battery cell
10: positive electrode plate
11: positive current collector
13: positive active material
15: positive electrode tab
17: positive electrode coated portion
19: positive electrode tab portion
20: positive electrode terminal
30: negative electrode plate
31: negative current collector
33: negative active material
35: negative electrode tab
37: negative electrode coated portion
39: negative electrode tab portion
40: negative electrode terminal
50: separator
51: film member
53: insulating material
60: pouch
70: notching die
71a: tab protrusion
71b: tab groove
73a: cutter blade
73b: cutter groove
80: welding jig
81: welding horn

What is claimed is:

1. A battery cell for an electric vehicle, comprising:
a plurality of positive electrode plates each including a positive current collector coated with a positive active material and having a plurality of positive electrode terminals in a first direction;
a plurality of negative electrode plates each including a negative current collector coated with a negative active material and having a plurality of negative electrode terminals in a second direction; and
a plurality of separators each including a film member coated with an insulating material and interposed between adjacent pair of the positive electrode plate and the negative electrode plate.

2. The battery cell of claim 1, wherein:
a first positive electrode tab and a second positive electrode tab uncoated with the positive active material are formed spaced apart from each other by a predetermined spacing in each of the positive electrode plates;
a first positive electrode terminal is electrically connected to the first positive electrode tab; and
a second positive electrode terminal is electrically connected to the second positive electrode tab.

3. The battery cell of claim 2, wherein the first and second positive electrode terminals are formed in a width in a range of about 40 mm to 50 mm and in a thickness in a range of about 0.1 mm to 0.2 mm.

4. The battery cell of claim 2, wherein the first and second positive electrode terminals are formed symmetrically at both sides with respect to a center in a length direction of the positive electrode plate.

5. The battery cell of claim 1, wherein:
a first negative electrode tab and a second negative electrode tab uncoated with the negative active material are formed spaced apart from each other by a predetermined spacing in each of the negative electrode plate;
a first negative electrode terminal is electrically connected to the first negative electrode tab; and
a second negative electrode terminal is electrically connected to the second negative electrode tab.

6. The battery cell of claim 5, wherein the first and second negative electrode terminals are formed in a width in a range of about 40 mm to 50 mm and in a thickness in a range of about 0.05 mm to 0.1 mm.

7. The battery cell of claim 5, wherein the first and second negative electrode terminals are formed symmetrically at both sides with respect to a center in a length direction of the negative electrode plate.

8. The battery cell of claim 1, wherein:
the plurality of positive electrode plates and the plurality of negative electrode plates are alternately stacked to dispose the positive electrode terminals and the negative electrode terminals in opposite directions; and
each adjacent pair of the positive and negative plates are insulated from each other by disposing the separator between the positive and negative plates.

9. The battery cell of claim 1, further comprising:
a pouch for sealing the positive electrode plates, the negative electrode plates, and the separators, while exteriorly exposing the positive electrode terminal and the negative electrode terminal.

10. The battery cell of claim 1, wherein:
the positive electrode plate includes a positive current collector formed of an aluminum (Al) thin film material; and
the negative electrode plate includes a negative current collector formed of a copper (Cu) thin film material.

11. A method for manufacturing a battery cell for an electric vehicle, comprising:
forming a plurality of positive electrode plates each having a first positive electrode tab and a second positive electrode tab;
forming a plurality of negative electrode plates each having a first negative electrode tab and a second negative electrode tab;
forming a plurality of separators each having a film member coated with an insulating material at both sides;
forming an electrode assembly by stacking the plurality of positive electrode plates, the plurality of negative electrode plates, and the plurality of separators, to alternately stack the positive electrode plates and the negative electrode plates and to insulate each adjacent pair of the positive and negative electrode plates by interposing the separator therebetween; and
connecting a plurality of positive electrode terminals to the positive electrode plates and a plurality of negative electrode terminals to the negative electrode plates.

12. The method of claim 11, wherein the forming of the plurality of positive electrode plates includes:
forming a positive electrode coated portion by coating a positive active material to both sides of a positive current collector except for a margin including a positive electrode tab portion;
loading the positive current collector to a notching die; and
forming the positive electrode plate by cutting the positive electrode tab portion to form the first positive electrode tab and the second positive electrode tab, and by cutting the positive current collector by a predetermined interval.

13. The method of claim 12, wherein the notching die comprises:
an upper die including a plurality of tab protrusions that form the first and second positive electrode tabs and a cutter blade for cutting the positive current collector by a predetermined interval; and
a lower die including a plurality of tab grooves that correspond to the plurality of tab protrusions and a cutter groove that corresponds to the cutter blade.

14. The method of claim 11, wherein the forming of the plurality of negative electrode plates includes:
forming a negative electrode coated portion by coating a negative active material to both sides of a negative current collector except for a margin including a negative electrode tab portion;
loading the negative current collector to a notching die; and
forming the negative electrode plate by cutting the negative electrode tab portion to form the first negative electrode tab and the second negative electrode tab, and by cutting the negative current collector by a predetermined interval.

15. The method of claim 14, wherein the notching die comprises:
an upper die including a plurality of tab protrusions that form the first and second negative electrode tabs and a cutter blade for cutting the negative current collector by a predetermined interval; and
a lower die including a plurality of tab grooves that correspond to the plurality of tab protrusions and a cutter groove that corresponds to the cutter blade.

16. The method of claim 11, wherein the forming of the electrode assembly includes:
welding the first positive electrode tabs of the plurality of positive electrode plates;
welding the second positive electrode tabs of the plurality of positive electrode plates;
welding the first negative electrode tabs of the plurality of negative electrode plates; and
welding the second negative electrode tabs of the plurality of negative electrode plates.

17. The method of claim 11, wherein the connecting of the plurality of positive electrode terminals to the positive electrode plates and the plurality of negative electrode terminals to the negative electrode plates includes:
loading the electrode assembly into a welding jig;
loading a first positive electrode terminal and a first negative electrode terminal to the first positive electrode tab and the first negative electrode tab, respectively;
welding the first positive electrode terminal and the first negative electrode terminal to the first positive electrode tab and the first negative electrode tab, respectively, by a welding horn;
loading a second positive electrode terminal and a second negative electrode terminal to the second positive electrode tab and the second negative electrode tab, respectively; and
welding the second positive electrode terminal and the second negative electrode terminal to the second positive electrode tab and the second negative electrode tab, respectively, by moving the welding horn.

18. The method of claim 17, wherein the welding includes ultrasonic welding.

19. The method of claim 11, further comprising sealing the electrode assembly by a pouch while exteriorly exposing at least a part of the electrode terminals.
